(19) United States
(12) Patent Application Publication
(10) Pub. No.: US 2020/0272385 A1
(43) Pub. Date: Aug. 27, 2020

(54) INFORMATION PROCESSING APPARATUS

(71) Applicant: KYOCERA Document Solutions Inc., Osaka (JP)

(72) Inventor: Nechelle NAVARRO, Osaka (JP)

(73) Assignee: KYOCERA Document Solutions Inc., Osaka (JP)

(21) Appl. No.: 16/793,779

(22) Filed: Feb. 18, 2020

(30) Foreign Application Priority Data
Feb. 25, 2019 (JP) 2019-031607

(51) Int. Cl. G06F 3/12

(52) U.S. Cl. CPC G06F 3/1253; G06F 3/1208

(57) ABSTRACT

An information processing apparatus has a communication portion communicating with an image forming apparatus, a display portion displaying a web page, an operation portion accepting an area specifying operation for specifying an area on the web page, and a control portion setting information as a printing target out of the information contained in the web page based on a specified area, generating print data of the information set as the printing target, and transmitting the print data to the image forming apparatus. When performing printing target setting processing in a first mode, the control portion sets information inside the specified area as the printing target. When performing the printing target setting processing in a second mode, the control portion sets information outside the specified area as the printing target.

### INCORPORATION BY REFERENCE

This application is based on and claims the benefit of Japanese Patent Application No. 2019-031607 filed on Feb. 25, 2019, the contents of which are hereby incorporated by reference.

### BACKGROUND

The present disclosure relates to an information processing apparatus that transmits print data to an image forming apparatus.

Connecting an information processing apparatus such as a personal computer to an image forming apparatus in such a way that they can communicate with each other enables the image forming apparatus to print a web page displayed on the information processing apparatus. In the printing of a web page displayed on the information processing apparatus, for example, the entire page of the web page being displayed is printed.

### SUMMARY

According to one aspect of the present disclosure, an information processing apparatus includes a communication portion, a display portion, an operation portion, and a control portion. The communication portion communicates with an image forming apparatus. The display portion displays a web page. The operation portion accepts an area specifying operation for specifying an area on the web page. The control portion performs printing target setting processing to set information as a printing target out of the information contained in the web page based on a specified area specified by the area specifying operation, generates print data of the information set as the printing target, and transmits the print data to the image forming apparatus by using the communication portion. The printing target setting processing has a first mode and a second mode. When performing the printing target setting processing in the first mode, the control portion sets inside-area information, which is information inside the specified area, as the printing target. When performing the printing target setting processing in the second mode, the control portion sets outside-area information, which is information outside the specified area, as the printing target.

### BRIEF DESCRIPTION OF THE DRAWINGS

FIG. 1 is a block diagram showing the configuration of an information processing apparatus according to one embodiment of the present disclosure;

FIG. 2 is a diagram showing part of a browser window displayed on the information processing apparatus according to the embodiment;

FIG. 3 is a diagram showing part of the browser window displayed on the information processing apparatus according to the embodiment (a diagram showing a pull-down menu related to an area specifying operation);

FIG. 4 is a diagram illustrating the area specifying operation (in a first mode) accepted by the information processing apparatus according to the embodiment;

FIG. 5 is a diagram illustrating the area specifying operation (in a second mode) accepted by the information processing apparatus according to the embodiment;

FIG. 6 is a flow chart showing the procedure of printing target setting processing in the first mode performed by the information processing apparatus according to the embodiment;

FIG. 7 is a diagram showing a state of a web page observed when a detail specifying operation is accepted by the information processing apparatus according to the embodiment;

FIG. 8 is a diagram showing a task bar displayed on the information processing apparatus according to the embodiment;

FIG. 9 is a flow chart showing the procedure of the printing target setting processing in the second mode performed by the information processing apparatus according to the embodiment;

FIG. 10 is a diagram showing part of the browser window displayed on the information processing apparatus according to the embodiment (a diagram showing a pull-down menu for displaying a print setting screen);

FIG. 11 is a diagram showing the print setting screen displayed on the information processing apparatus according to the embodiment (a screen including a preview image in a text mode);

FIG. 12 is a diagram showing the print setting screen displayed on the information processing apparatus according to the embodiment (a screen including a preview image in an image mode); and

FIG. 13 is a flow chart showing the procedure of data generation processing performed by the information processing apparatus according to the embodiment.

### DETAILED DESCRIPTION

Hereinafter, an information processing apparatus according to one embodiment of the present disclosure will be described, with a personal computer taken as an example. The present disclosure is applicable not only to personal computers but also smartphones and the like.

Configuration of an Information Processing Apparatus

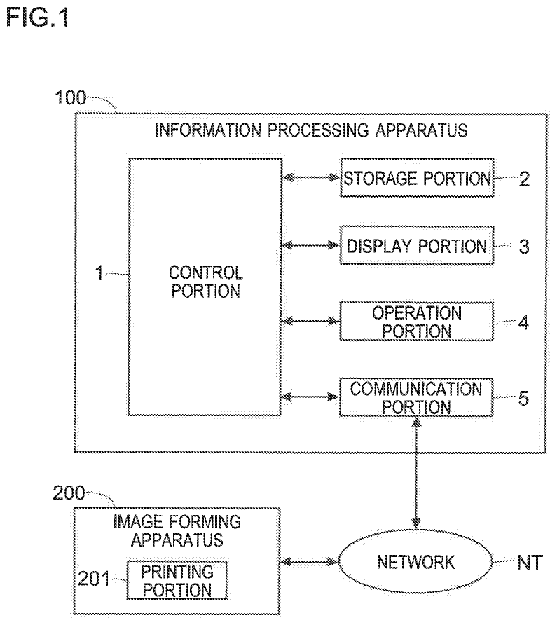

As shown in FIG. 1, the information processing apparatus 100 according to the embodiment includes a control portion 1, a storage portion 2, a display portion 3, an operation portion 4, and a communication portion 5.

The control portion 1 includes a CPU. The control portion 1 controls the information processing apparatus 100 based on control programs and control data. The control portion 1 also performs character recognition processing (OCR processing) based on a character recognition program and a character data base.

The storage portion 2 includes storage devices such as ROM, a RAM, and a HDD. The storage portion 2 stores control programs and control data. The storage portion 2 is connected to the control portion 1. The control portion 1 writes data to and reads data from the storage portion 2.

The display portion 3 is a liquid crystal display. Any other type of display such as an organic EL display can also be used as the display portion 3. The operation portion 4 includes a hardware keyboard and a pointing device. In an information processing apparatus 100 provided with a touch screen, the touch screen serves as the display portion 3 and the operation portion 4. The control portion 1 controls the display operation of the display portion 3. The control portion 1 also detects operation accepted on the operation portion 4.

The communication portion 5 is communicably connected to a network NT such as a LAN or the Internet. The communication portion 5 includes a communication circuit, a communication memory, a communication connector, and the like. The communication portion 5 is connected to the control portion 1. The control portion 1, by using the communication portion 5, communicates with an external device connected to the network NT.

To the network NT, an image forming apparatus 200 is connected. On the information processing apparatus 100, a printer driver is installed. The printer driver is stored in the storage portion 2. The information processing apparatus 100 and the image forming apparatus 200 together constitute an image formation system.

With the information processing apparatus 100 and the image forming apparatus 200 communicably connected together, print data can be transmitted from the information processing apparatus 100 to the image forming apparatus 200. The image forming apparatus 200 executes a print job based on the print data received from the information processing apparatus 100. The image forming apparatus 200 includes a printing portion 201. In a print job, the printing portion 201 conveys a sheet, forms an image to be printed, and prints the image on the sheet being conveyed.

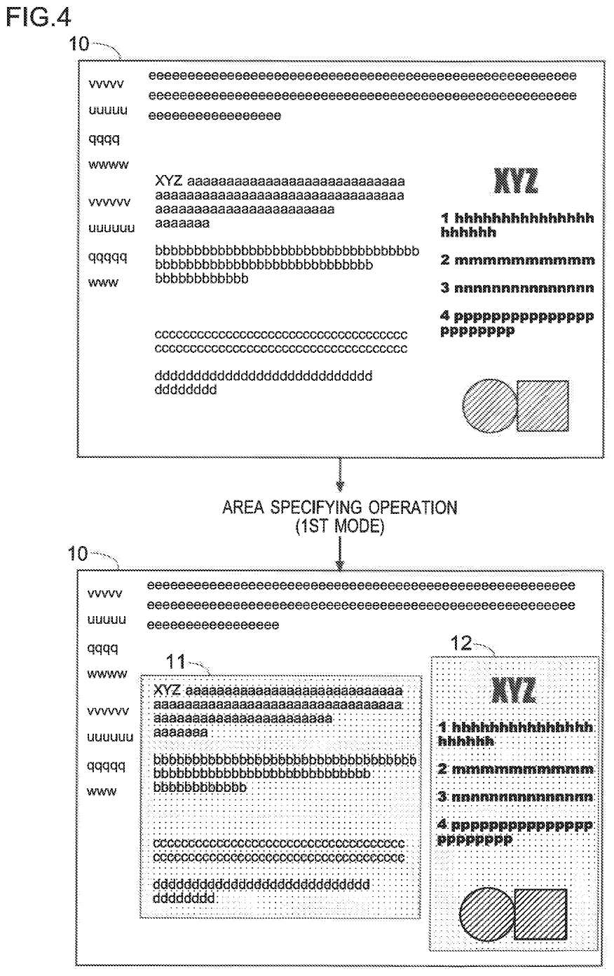

Here, on the information processing apparatus 100, a browser is installed. The browser is stored in the storage portion 2. The browser is used to browse a web page 10 (see FIGS. 4, 5, and 7). In the diagrams referred to in the course of the following description, of the information constituting the web page 10, texts are represented by strings of alphabetical and numerical characters, and images (photos and figures) are represented by hatched areas.

Though not shown, the display portion 3 displays a browser icon. When the control portion 1 detects operation on the browser icon, it starts up the browser. In this way, a web page 10 can be displayed on the display portion 3.

Setting a Printing Target

The browser installed on the information processing apparatus 100 has a selective printing function whereby, out of the information (texts, figures, photos, etc.) constituting the web page 10 being displayed, user-specified information can be selectively printed. The selective printing function can be added to the browser by, for example, incorporating into the browser an add-in program (plug-in program) corresponding to the selective printing function.

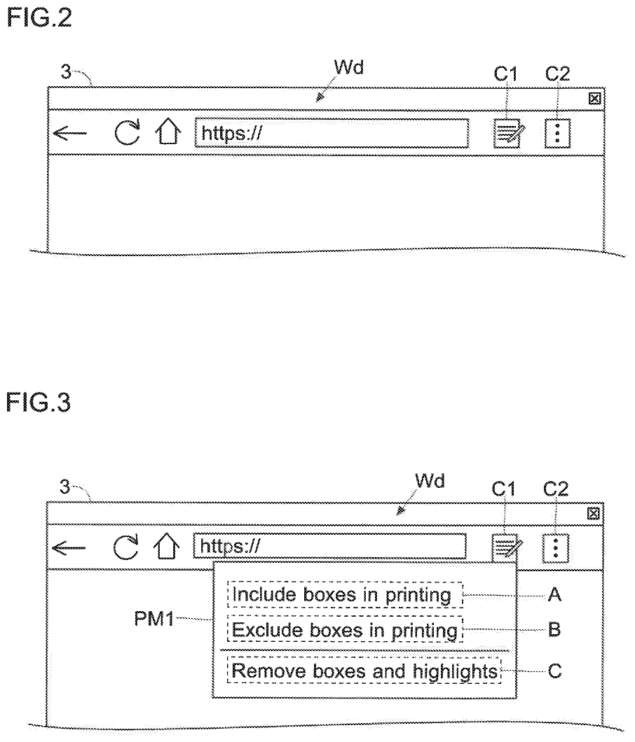

The control portion 1 makes the display portion 3 display, for example, a browser window Wd as shown in FIG. 2. A web page 10 is displayed in the browser window Wd.

The browser window Wd includes an icon C1 corresponding to the selective printing function. Running the add-in program corresponding to the selective printing function enables operation on the icon C1.

When the control portion 1 recognizes operation on the icon C1, the control portion 1 makes the display portion 3 display a pull-down menu PM1 as shown in FIG. 3. The pull-down menu PM1 shows, as alternatives, option A (the option that reads “Include boxes in printing”), option B (the option that reads “Exclude boxes in printing”), and option C (the option that reads “Remove boxes and highlights”). The operation portion 4 accepts as an option selecting operation an operation of putting the pointer over and clicking on the display region of either option A or option B.

When either option A or option B is selected by the option selecting operation, the control portion 1 makes the operation portion 4 accept an area specifying operation for specifying an area on the web page 10. The operation portion 4 accepts as the area specifying operation a drag-and-drop operation (an operation of moving the pointer while holding a button on the pointing device pressed and then releasing the button). By the area specifying operation, it is possible to specify a rectangular area of which a diagonal line connects between the start position of the area specifying operation and the end position of the area specifying operation.

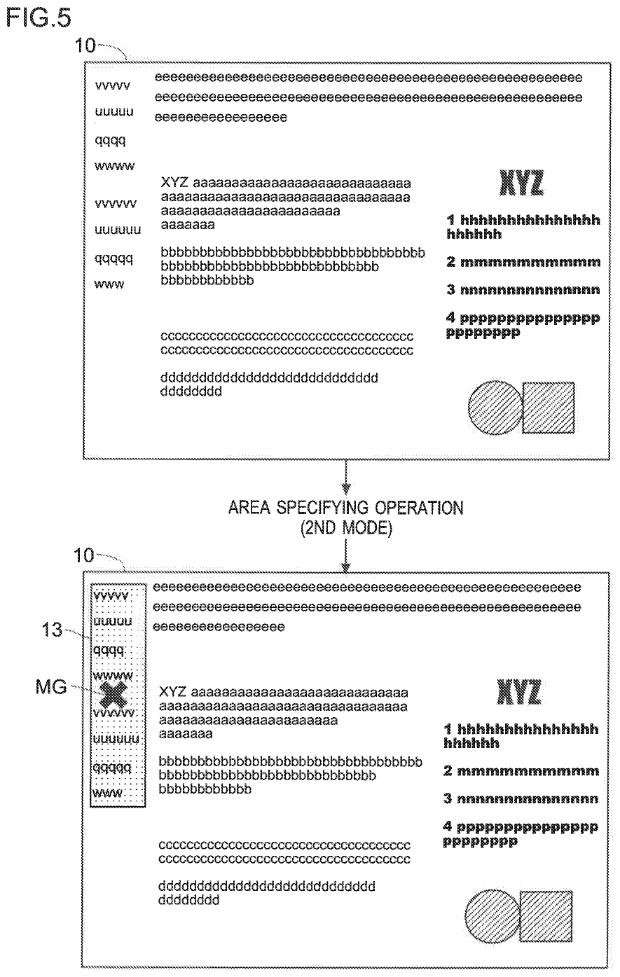

The control portion 1 recognizes, as a specified area, the area specified by the area specifying operation. Then, as shown in FIGS. 4 and 5, the control portion 1 instructs the display portion 3 to perform processing to change the display appearance (such as display color) of the specified area. When there are a plurality of specified areas (when a plurality of areas have been specified by the area specifying operation), the display appearance of each of the plurality of specified areas is changed (see FIG. 4). The display appearance of a plurality of specified areas may be varied from each other. Though not shown, a frame image that encloses a specified area may be shown. In FIGS. 4 and 5, the web page before the area specifying operation is shown in an upper part of the diagram, and the web page after the area specifying operation is shown in a lower part of the diagram. Specified areas are indicated by dotted patterns. In FIG. 4, specified areas are identified by the reference signs 11 and 12, and in FIG. 5, a specified area is identified by the reference sign 13.

When the control portion 1 detects operation on option C in the pull-down menu PM1 (an operation of putting the pointer over and clicking on the display region of option C), the control portion 1 instructs the display portion 3 to change the display appearance of the specified area back to the original appearance. In other words, the control portion 1 cancels the specification of the area by the area specifying operation.

Here, the control portion 1 performs printing target setting processing to set, based on the specified area, printing target information out of the information contained in the web page 10. The printing target setting processing has a first mode and a second mode. When option A is selected by the option selecting operation, the control portion 1 performs the printing target setting processing in the first mode. When option B is selected by the option selecting operation, the control portion 1 performs the printing target setting processing in the second mode. This will be described specifically below.

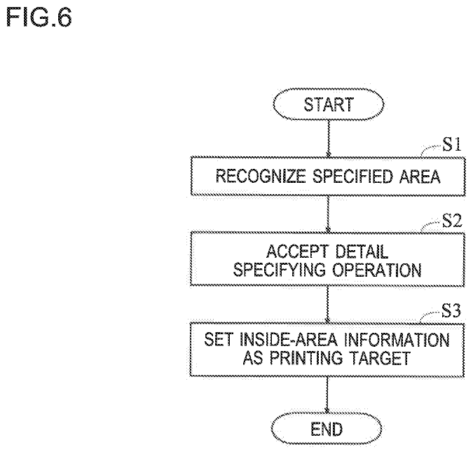

First, with reference to the flow chart shown in FIG. 6, the procedure of the printing target setting processing in the first mode will be described. The procedure in FIG. 6 starts when an area is specified by the area specifying operation.

At step S1, the control portion 1 recognizes the specified area. In the first mode, the information in the specified area can be a printing target. In the following description, the information in the specified area will be referred to as the inside-area information.

At step S2, the control portion 1 makes the operation portion 4 accept a detail specifying operation for specifying partial information out of the inside-area information. When there are a plurality of specified areas, the detail specifying operation is performed for each of the specified areas. The detail specifying operation may be performed for all of the plurality of specified areas, or may be performed for some of the plurality of specified areas and not performed for the other specified areas. The detail specifying operation may not be performed at all.

At step S3, the control portion 1 sets the inside-area information as the printing target. If there are a plurality of specified areas, the plurality of pieces of inside-area information present in the plurality of specified areas respectively are set as the printing target.

If there is any specified area for which the detail specifying operation has been performed, the control portion 1 sets as the printing target the information specified by the detail specifying operation out of the inside-area information in the specified area for which the detail specifying operation was performed, and does not set as the printing target the information other than that specified by the detail specifying operation. There may be cases where a specified area for which the detail specifying operation has been performed (hereinafter referred to as a first specified area) and a specified area for which the detail specifying operation has not been performed (hereinafter referred to as a second specified area) coexist. In that case, the control portion 1, for the first specified area, sets as the printing target only the information specified by the detail specifying operation and, for the second specified area, sets as the printing target all of the inside-area information.

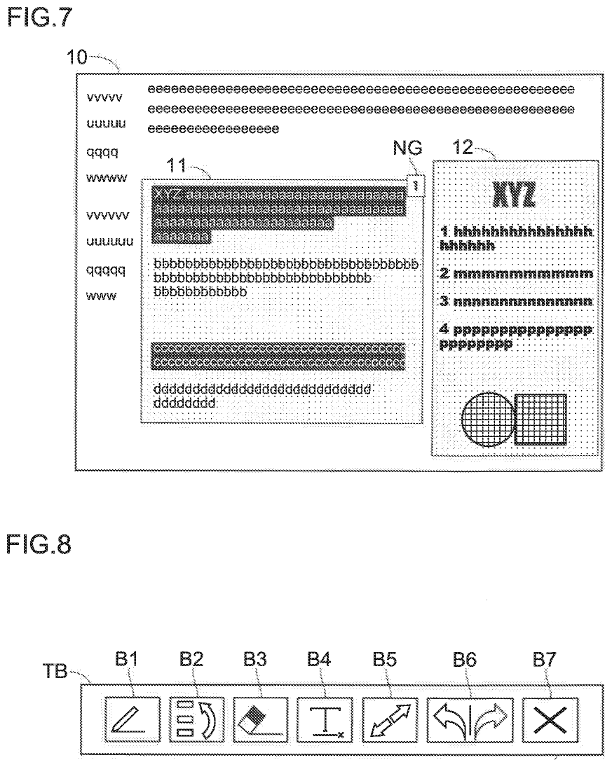

Now, with reference to FIGS. 7 and 8, the detail specifying operation will be described.

When the printing target setting processing is performed in the first mode, it proceeds as follows. After an area is specified by the area specifying operation, when the control portion 1 detects operation on the specified area (an operation of putting the pointer over and clicking on the specified area), the control portion 1 recognizes the operated specified area as the editing target. The control portion 1 then makes the display portion 3 display a task bar TB (see FIG. 8). The display portion 3 displays the task bar TB on a web page 10. The display portion 3 shows the task bar TB close to the specified area recognized as the editing target. Or the display portion 3 shows the task bar TB in contact with the specified area recognized as the editing target. The task bar TB includes a button 61. When the control portion 1 detects operation on the button B1, the control portion 1 makes the operation portion 4 accept the detail specifying operation on the specified area as the editing target.

For example, in the example shown in FIG. 7, consider a case where operation is performed on, out of the specified areas 11 and 12, the specified area 11 and then operation is performed on the button B1 in the task bar TB displayed as the result. In this case, the control portion 1 recognizes the specified area 11 as the editing target. The control portion 1 then validates the detail specifying operation on the specified area 11. In this condition, even if the detail specifying operation is performed on the specified area 12, that operation is handled as invalid. When the detail specifying operation has to be performed on the specified area 12, the specified area 12 needs to be set as the editing target.

When the detail specifying operation is performed, the control portion 1 sets as the printing target the information specified by the detail specifying operation out of the inside-area information in the specified area 11. The information specified by the detail specifying operation is shown, for example, highlighted. In FIG. 7, the information shown highlighted is displayed in reverse video.

The task bar TB includes, in addition to the button B1, buttons B2, B3, B4, B5. B6, and B7.

When there are a plurality of specified areas, the control portion 1 validates operation on the button B2. When the control portion 1 detects operation on the button B2, the control portion 1 makes the operation portion 4 accept an order specifying operation for specifying the arrangement order of the inside-area information in the specified areas as the editing target. For example, the control portion 1 recognizes a value entered with hardware keys as the number indicating a position in the order.

When the order specifying operation is performed, the control portion 1 assigns the inside-area information in the specified area as the editing target the position in the order specified by the order specifying operation. The control portion 1 then instructs the display portion 3 to display in the specified area as the editing target the number indicating the position in the order specified by the order specifying operation.

For example, suppose that, in the example shown in FIG. 7, the order specifying operation is performed for the specified area 11. Assume that the position in the order specified by the order specifying operation is “1”. In this case, the inside-area information in the specified area 11 is assigned “1” as the position in the order. As a result, a numerical image NG indicating the position in the order “1” is displayed in the area of the specified area 11.

When the order specifying operation is performed, the control portion 1 generates print data based on the specified order specified by the order specifying operation. This will be discussed in detail later.

The buttons B3 and B4 in the task bar TB are each a button for canceling the specification of the information specified by the detail specifying operation.

When the control portion 1 detects operation on the button B3, the control portion 1 makes the operation portion 4 accept an operation for specifying the information to be canceled out of the information specified by the detail specifying operation. The control portion 1 then cancels the specification of the information to be canceled. When the control portion 1 detects operation on the button B4, the control portion 1 cancels the specification of all the information specified by the detail specifying operation.

The button B5 in the task bar TB is a button for accepting change of the size (enlargement and reduction) of the specified area as the editing target or movement of the specified area as the editing target. After operating the button B5, putting the pointer on and drag-and-dropping the specified area as the editing target allows changing the size of the specified area as the editing target or moving the specified area as the editing target.

Operating the button B6 in the task bar TB allows canceling the editing (such as size change, movement, and deletion) or redoing the cancelled editing. Operating the button B7 in the task bar TB allows returning to the state where no specified area is specified as the editing target.

After the task bar TB is displayed, when the control portion 1 detects operation outside the specified area (an operation of putting the pointer outside the specified area and clicking there), the control portion 1 stops the task bar TB from being displayed. That is, the task bar TB disappears.

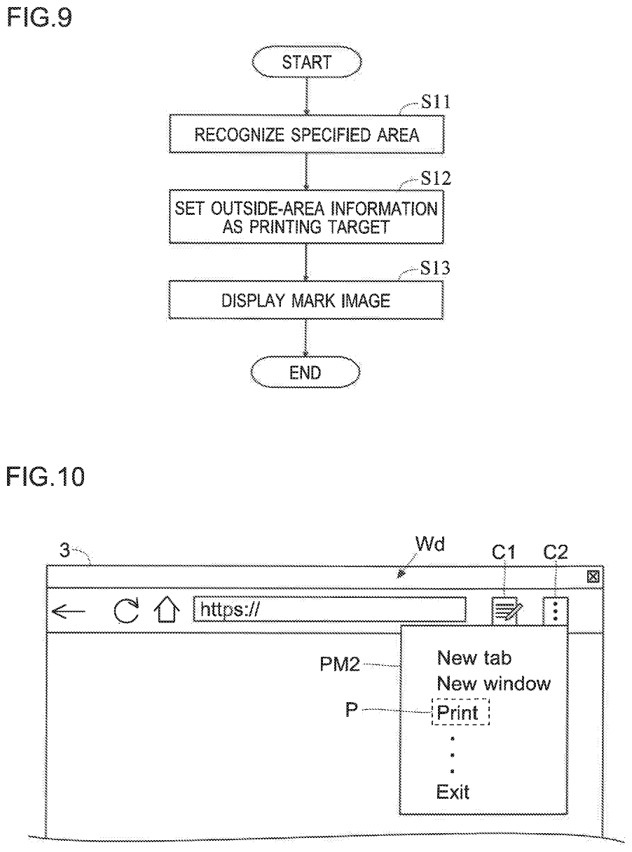

Next, with reference to the flow chart shown in FIG. 9, the procedure of the printing target setting processing in the second mode will be described. The procedure shown in FIG. 9 starts when an area is specified by the area specifying operation.

At step S11, the control portion 1 recognizes the specified area. Then, at step S12, the control portion 1 sets outside-area information, which is information outside the specified area, as the printing target. Thus, in the second mode, inside-area information is not taken as the printing target.

At step S13, the control portion 1 makes the display portion 3 display a previously determined mark image MG (see FIG. 5, the lower part) that indicates that the specified area is an area not to be printed. As shown in the lower part of FIG. 5, the mark image MG is, for example, an image of an X-shaped symbol. The display portion 3 shows the mark image MG inside the specified area.

When the printing target setting processing is performed in the second mode, it proceeds as follows. After an area is specified by the area specifying operation, when the control portion 1 detects operation on the specified area (an operation of putting the pointer over and clicking on the specified area), the control portion 1 makes the display portion 3 display a cancel button (not shown). The display portion 3 shows the cancel button near the specified area on which the operation was detected. Or the display portion 3 shows the cancel button in contact with the specified area on which the operation was detected. When the control portion 1 detects operation on the cancel button, the control portion 1 instructs the display portion 3 to perform processing for changing the display appearance of the specified area back to the original appearance. In other words, the specification of the area by the area specifying operation is canceled.

Generating Print Data

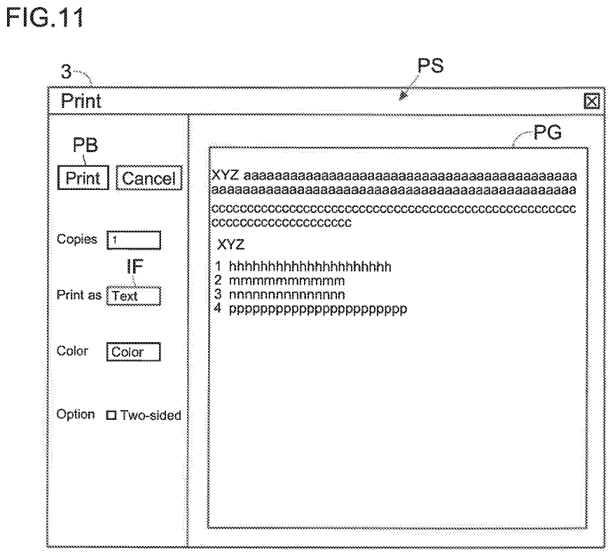

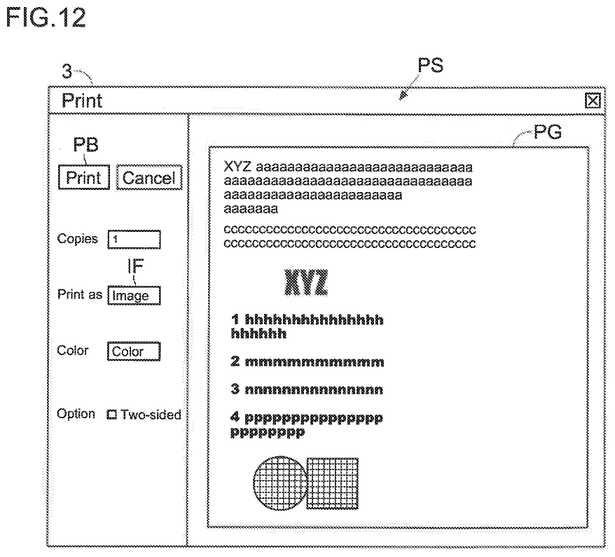

When the control portion 1 detects operation on an icon C2 (see FIGS. 2 and 3) in the browser window Wd, the control portion 1 makes the display portion 3 display a pull-down menu PM2 as shown in FIG. 10. The pull-down menu PM2 includes an option P that reads “Print”. When the control portion 1 detects operation in the display region of the option P (an operation of putting the pointer over and clicking on the display region of the option P), the control portion 1 makes the display portion 3 display a print setting screen PS as shown in FIGS. 11 and 12.

On the print setting screen PS, a mode selecting operation for choosing between a text mode and an image mode is accepted. If the text mode is chosen in the mode selecting operation, an indication “Text” appears in an input box IF (see FIG. 11). If the image mode is chosen in the mode selecting operation, an indication “Image” appears in an input box IF (see FIG. 12). The mode selecting operation is performed by choosing one of the modes from the pull-down menu. For example, at the start of the display of the print setting screen PS, the input box IF is blank.

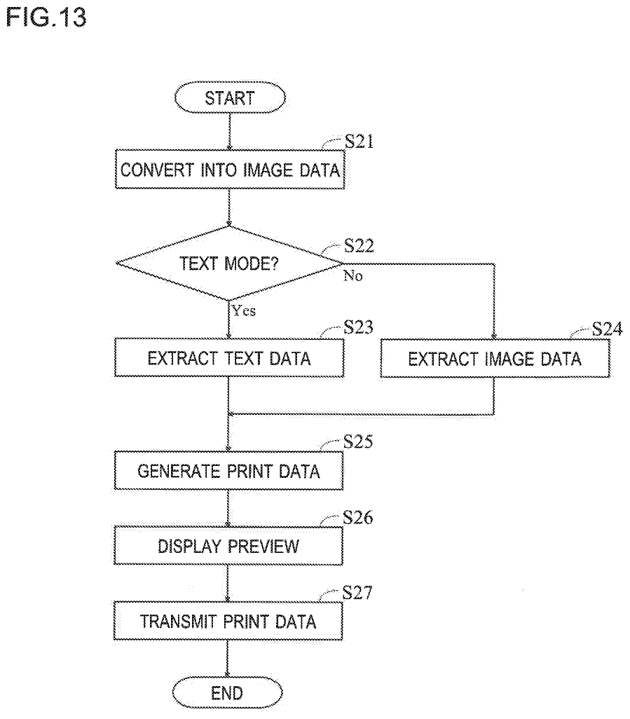

When the mode selecting operation is performed, the control portion 1 performs data generation processing to generate print data for printing on a sheet the information set as the printing target in the printing target setting processing. The procedure of the data generation processing will be described below with reference to the flow chart shown in FIG. 13. The procedure shown in FIG. 13 starts when the mode selecting operation is performed on the print setting screen PS (when the mode selected by the mode selecting operation is entered in the input box IF).

At step S21, the control portion 1 converts an entire web page 10 into image data. In the following description, the image data of the entire web page 10 will be referred to as the entire image data.

At step S22, the control portion 1 checks whether the text mode has been selected in the mode selecting operation. If the control portion 1 judges that the text mode has been selected, the procedure proceeds to step S23; if the control portion 1 judges that the image mode has been selected, the procedure proceeds to step S24.

At step S23, the control portion 1 performs character recognition processing on the entire area of the entire image data. The control portion 1 then extracts the text data that corresponds to the information as the printing target. When the printing target setting processing in the first mode was performed, the control portion 1 extracts inside-area text data, which is the text data of inside-area information. When the printing target setting processing in the second mode was performed, the control portion 1 extracts outside-area text data, which is the text data of outside-area information. The procedure then proceeds to step S25.

At step S23, character recognition processing does not necessarily need to be performed on the entire area of the entire image data. Specifically, when the printing target setting processing in the first mode was performed, character recognition processing may be performed in the region corresponding to the specified area, with no character recognition processing performed in the region outside the specified area. When the printing target setting processing in the second mode was performed, character recognition processing may be performed in the region outside the specified area out of the entire image data, with no character recognition processing performed in the region corresponding to the specified area.

At step S24, the control portion 1 extracts the image data of the region that corresponds to the information as the printing target out of the entire image data. When the printing target setting processing in the first mode was performed, the control portion 1 extracts inside-area image data, which is the image data of the region corresponding to inside-area information. When the printing target setting processing in the second mode was performed, the control portion 1 extracts outside-area image data, which is the image data of the region corresponding to outside-area information. The procedure then proceeds to step S25.

At step S25, the control portion 1 generates print data. Reaching step S25 from step S23 results in the control portion 1 generating the print data of the extracted text data obtained at step S23. Reaching step S25 from step S24 results in the control portion 1 generating the print data of the extracted image data obtained at step S24.

Here, in a case where a plurality of pieces of inside-area information corresponding respectively to a plurality of specified areas are set as the printing target, the control portion 1, when generating the print data, performs order setting processing to set the arrangement order of the plurality of pieces of inside-area information in the print data. The order setting processing has first processing and second processing. The first processing is performed when the order specifying operation has not been accepted. The second processing is performed when the order specifying operation has been accepted.

When the first processing is performed, the control portion 1 sets the arrangement order of the plurality of pieces of inside-area information in the print data based on the positions of the plurality of specified areas on the display screen (web page 10). For example, the control portion 1 sets the arrangement order of the plurality of pieces of inside-area information in the print data such that they are in the earlier positions in the order the closer to the upper left corner of the display screen the positions of the corresponding specified areas on the display screen are. That is, the piece of inside-area information the position of the specified area corresponding to which is the closest to the upper left corner of the display screen is given the first position in the arrangement order in the print data, and the piece of inside-area information the position of the specified area corresponding to which is the farthest from the upper left corner of the display screen is given the last position in the arrangement order in the print data.

When the second processing is performed, the control portion 1 recognizes the specified order specified by the order specifying operation. The control portion 1 sets the arrangement order of the plurality of pieces of inside-area information in the print data based on the specified order.

For example, in the example shown in FIG. 7, the inside-area information in the specified area 11 (the information specified by the detail specifying operation) is given the first position in the arrangement order in the print data, and the inside-area information in the specified area 12 is given the second position (last position). In this example, even if the order specifying operation has not been performed, the specified area 11 is closer than the specified area 12 to the upper left corner of the display screen, and thus the inside-area information in the specified area 11 is given the first position in the arrangement order in the print data.

After step S25, the procedure proceeds to step 526. At step S26, the control portion 1 generates display data for a preview that corresponds to the print data, and makes the display portion 3 perform preview display based on the preview display data. In other words, the control portion 1 generates a preview image PG (see FIGS. 11 and 12) corresponding to the print data. The display portion 3 displays the preview image PG on the print setting screen PS.

For example, in the example shown in FIG. 7, when the text mode is chosen, a preview image PG as shown in FIG. 11 is displayed. In the example shown in FIG. 7, when the image mode is chosen, a preview image PG as shown in FIG. 12 is displayed.

After step 526, the procedure proceeds to step S27. At step 527, the control portion 1 transmits the print data to the image forming apparatus 200 by using the communication portion 5. The print setting screen PS includes a print button PB (see FIGS. 11 and 12) for accepting an instruction to perform printing. When the control portion 1 detects operation on the print button PB, the control portion 1 transmits the print data to the image forming apparatus 200. When the image forming apparatus 200 receives the image data from the information processing apparatus 100, the image forming apparatus 200 performs printing based on the print data.

As described above, according to the embodiment, an information processing apparatus 100 includes: a communication portion 5 that communicates with an image forming apparatus 200; a display portion 3 that displays a web page 10; an operation portion 4 that accepts an area specifying operation for specifying an area on the web page 10; and a control portion 1 that performs printing target setting processing to set information as a printing target out of the information contained in the web page 10 based on a specified area specified by the area specifying operation, the control portion 1 generating print data of the information set as the printing target, the control portion 1 transmitting the print data to the image forming apparatus 200 by using the communication portion 5. The printing target setting processing has a first mode and a second mode. When performing the printing target setting processing in the first mode, the control portion 1 sets inside-area information, which is information inside the specified area, as the printing target. When performing the printing target setting processing in the second mode, the control portion 1 sets outside-area information, which is information outside the specified area, as the printing target.

With the configuration according to the embodiment, it is possible to print only the needed information out of the web page 10. This is convenient to the user.

When the printing target setting processing is performed in the first mode, information inside the specified area specified by the area specifying operation is printed. This is convenient to the user, because the user has only to specify by the area specifying operation the area that includes the information that the user wants to print out of the web page 10. Even if the information that the user wants to print out of the web page 10 is spread over a plurality of places, by specifying a plurality of areas by the area specifying operation (performing the area specifying operation a plurality of times), the user can print the information spread over the plurality of places in a consolidated manner.

When the printing target setting processing is performed in the second mode, information outside the specified area specified by the area specifying operation is printed. Thus, when there is unnecessary information in part of the web page 10 (when the user wants to print it all except the unnecessary information), the user has only to specify by the area specifying operation an area that contains the unnecessary information. This is convenient to the user, because the user only needs to perform the area specifying operation once.

According to the embodiment, preferably, as described previously, when performing the printing target setting processing in the first mode, the control portion 1, if the operation portion 4 has accepted the detail specifying operation, does not set information other than the partial information specified by the detail specifying operation out of the inside-area information as the printing target. With this configuration, when unnecessary information is contained in the specified area, information other than the unnecessary information can be specified by the detail specifying operation, and thereby the unnecessary information can be excluded from the printing target. This is convenient to the user, because the user does not need to perform the area specifying operation all over again.

According to the embodiment, preferably, as described previously, when performing the printing target setting processing in the first mode, the control portion 1, if there are a plurality of specified areas, sets a plurality of pieces of inside-area information respectively corresponding to the plurality of specified areas as the printing target and thereafter, when generating the print data, the control portion 1 sets the arrangement order of the plurality of pieces of inside-area information in the print data (the printing positions of the plurality of pieces of inside-area information) based on the positions of the plurality of specified areas on the web page 10. With this configuration, without specifying the arrangement order of the plurality of pieces of inside-area information in the print data that are to be printed on a sheet, the user can print the plurality of pieces of inside-area information in the arrangement order corresponding to the positions of the plurality of specified areas on the web page 10 corresponding to the plurality of pieces of inside-area information.

According to the embodiment, preferably, as described previously, when generating the print data, the control portion 1, if the operation portion 4 has accepted the order setting operation, sets the arrangement order of the plurality of pieces of inside-area information in the print data (the printing positions of the plurality of pieces of inside-area information) based on the order specified by the order setting operation. This results in enhanced convenience to the user, because the user can freely set the printing positions of the plurality of pieces of inside-area information.

According to the embodiment, preferably, as described previously, in a case where the text mode is chosen by the mode selecting operation, when the printing target setting processing has been performed in the first mode, the control portion 1 extracts inside-area text data, which is text data of the inside-area information, and generates print data of the inside-area text data. On the other hand, in a case where the text mode is chosen by the mode selecting operation, when the printing target setting processing has been performed in the second mode, the control portion 1 extracts outside-area text data, which is text data of the outside-area information, and generates print data of the outside-area text data. This results in enhanced convenience to a user who wants to print the needed information (the information that the user wants to print) on the web page 10 not as an image but as a text. For example, when the needed information only contains strings of characters, printing it as a text makes the printed information easy to read. It is thereby possible to reduce the number of lines of information spread across a plurality of lines for the sake of balance with other content on the web page 10.

According to the embodiment, preferably, as described previously, in a case where the image mode is chosen by the mode selecting operation, when the printing target setting processing has been performed in the first mode, the control portion 1 extracts inside-area image data, which is image data of a region corresponding to the inside-area information out of the image data of the web page 10, and generates print data of the inside-area image data. On the other hand, in a case where the image mode is chosen by the mode selecting operation, when the printing target setting processing has been performed in the second mode, the control portion 1 extracts outside-area image data, which is image data of a region corresponding to the outside-area information out of the image data of the web page 10, and generates print data of the outside-area image data, With this configuration, the user can print the needed information on the web page 10 while keeping its appearance on the web page 10.

According to the embodiment, preferably, as described previously, the control portion 1 generates display data (a preview image PG) corresponding to the print data, and makes the display portion 3 perform preview display based on the display data. That is, the display portion 3 generates a preview image PG. With this configuration, the user can preview the print result before printing, and this results in enhanced convenience to the user.

According to the embodiment, preferably, as described previously, when performing the printing target setting processing in the second mode, the control portion 1 makes the display portion 3 display a previously determined mark image MG indicating that the specified area is an area not to be printed. With this configuration, it is possible to prevent the user from mistaking the specified area for a region to be printed.

The embodiment disclosed herein should be understood to be in every aspect illustrative and not restrictive. The scope of the present disclosure is defined not by the description of the embodiment given above but by the appended claims and encompasses any modifications made within the spirit and scope of what is recited in the claims.

What is claimed is:

1. An information processing apparatus comprising:
a communication portion that communicates with an image forming apparatus;
a display portion that displays a web page;
an operation portion that accepts an area specifying operation for specifying an area on the web page; and
a control portion that performs printing target setting processing to set information as a printing target out of information contained in the web page based on a specified area specified by the area specifying operation, the control portion generating print data of the information set as the printing target, the control portion transmitting the print data to the image forming apparatus by using the communication portion,
wherein
the printing target setting processing has a first mode and a second mode,
when performing the printing target setting processing in the first mode, the control portion sets inside-area information, which is information inside the specified area, as the printing target, and
when performing the printing target setting processing in the second mode, the control portion sets outside-area information, which is information outside the specified area, as the printing target.

2. The information processing apparatus according to claim 1, wherein
the operation portion accepts a detail specifying operation for specifying partial information out of the inside-area information, and
when performing the printing target setting processing in the first mode, the control portion, if the operation portion has accepted the detail specifying operation, does not set information other than the information specified by the detail specifying operation out of the inside-area information as the printing target.

3. The information processing apparatus according to claim 1, wherein
when performing the printing target setting processing in the first mode, the control portion, if there are a plurality of the specified areas, sets a plurality of pieces of the inside-area information respectively corresponding to the plurality of the specified areas as the printing target and thereafter, when generating the print data, the control portion sets an arrangement order of the plurality of pieces of the inside-area information in the print data based on positions of the plurality of the specified areas on the web page.

4. The information processing apparatus according to claim 3, wherein
the operation portion accepts an order setting operation for specifying respective positions of the plurality of pieces of the inside-area information in the arrangement order, and
when generating the print data, the control portion, if the operation portion has accepted the order setting operation, sets the arrangement order of the plurality of pieces of the inside-area information in the print data based on the order specified by the order setting operation.

5. The information processing apparatus according to claim 1, wherein
when the printing target setting processing has been performed in the first mode, the control portion extracts inside-area text data, which is text data of the inside-area information, and generates print data of the inside-area text data, and
when the printing target setting processing has been performed in the second mode, the control portion extracts outside-area text data, which is text data of the outside-area information, and generates print data of the outside-area text data.

6. The information processing apparatus according to claim 1, wherein
the control portion converts the web page into image data,
when the printing target setting processing has been performed in the first mode, the control portion extracts inside-area image data, which is image data of a region corresponding to the inside-area information out of the image data of the web page, and generates print data of the inside-area image data, and
when the printing target setting processing has been performed in the second mode, the control portion extracts outside-area image data, which is image data of a region corresponding to the outside-area information out of the image data of the web page, and generates print data of the outside-area image data.

7. The information processing apparatus according to claim 1, wherein
the control portion generates display data corresponding to the print data, and makes the display portion perform display based on the display data.

8. The information processing apparatus according to claim 1, wherein
when performing the printing target setting processing in the second mode, the control portion makes the display portion display a previously determined mark image indicating that the specified area is an area not to be printed.
